(19) United States
(12) Patent Application Publication
(10) Pub. No.: US 2012/0321810 A1
(43) Pub. Date: Dec. 20, 2012

(54) METHOD FOR DEPOSITING A LAYER OF ORGANIZED PARTICLES ON A SUBSTRATE

(76) Inventors: Zoe Tebby, Le Grand Pressigny (FR); Olivier Dellea, La Talaudiere (FR)

(21) Appl. No.: 13/578,707

(22) PCT Filed: Jan. 28, 2011
(86) PCT No.: PCT/FR2011/050166

§ 371 Date: Aug. 13, 2012

(30) Foreign Application Priority Data
Mar. 2, 2010 (FR) 1051496

(51) Int. Cl. B05D 1/18; B05D 7/00

(52) U.S. Cl. 427/443.2; 427/430.1

(57) ABSTRACT

A method for depositing a layer of organized particles on a substrate. This method includes the steps of: controlled stirring of a bath including at least the particles and a mixture of solvents formed of at least 50% by volume of ethanol; dipping of the substrate into the stirred bath; and removal of said substrate from the stirred bath.

### TECHNICAL FIELD

The present disclosure relates to a method for depositing a layer of organized particles on a substrate. This method is particularly well adapted for large surface areas, on the order of tens of square centimeters, and for large particles, of several hundreds of nanometers.

Such substrates covered with a layer of organized particles may especially be used in the field of surface processing such as soft lithography, antireflection layers, or surface structuring.

### BACKGROUND OF THE INVENTION

The two main prior art techniques enabling to deposit monolayers of organized particles are the Langmuir-Blodgett method and the “dip coating” method, respectively.

The Langmuir-Blodgett method comprises transferring a floating monolayer onto a solid substrate after dipping. It also comprises dispersing the particles in a solvent which is placed on water. While the solvent is partially evaporated, the particle film floating at the water surface is compressed by a mobile barrier. This method enables to organize the particles by forcing them or confining them in a minimum space. They thus take a structure of compact hexagonal type, leaving little free space on the surface. The substrate is then vertically dipped into the solution before being removed from it. The floating monolayer is thus transferred to the substrate surface by capillarity. The substrate may be covered with several monolayers by successive dippings.

Despite its advantages and its simplicity, the Langmuir-Blodgett method, which is much used in the deposition of organized particles, remains little adapted to large substrates.

Further, obtaining compact layers by this technique takes a long time (S. Parvin et al. “Side-chain effect on Langmuir and Langmuir-Blodgett film properties of poly(N-alkylmethacrylamide)-coated magnetic nanoparticle”, J. of Colloid and Interface Science, 2007, vol. 313, pp. 128-134; B. R. Jackson et al. “Self-assembly of monolayer-thick alumina particle-epoxy composite films”, Langmuir, 2007, vol. 23, n° 23, pp. 11399-11403).

The dip coating technology is another method currently used in the deposition of organized particles at the surface of a substrate. This technique relates to the dipping and the removal of the substrate in a particle suspension or colloid, thus enabling the particles to be transferred towards the substrate surface. The two main factors to be controlled in this technique are the particle concentration and the removal rate. Indeed, compact layers can be obtained by controlling the particle concentration, while the determination of the right removal rate enables the solvent to evaporate at the level of the meniscus of the solution. Capillary forces thus enable the particles to self-organize It is however important to minimize the substrate immersion time to avoid a particle sedimentation as micrometric particles are being deposited. Indeed, gravity forces cause the sedimentation of particles and thus cannot be neglected.

Conversely to the Langmuir-Blodgett method, the dip coating method is faster to implement and better adapted to larger supports, having dimensions on the order of several centimeters (Y. Wang, et al. “Solution processed large area surface textures based on dip coating”, IEEE, 2008, 978-1-4244-2104-6/08).

However, the particle sedimentation phenomenon results in a lack of homogeneity of the solution, thus jeopardizing the possibility of creating homogeneous depositions on large surface areas. The particle sedimentation is enhanced by long substrate immersion times, thus making the results obtained by this deposition method difficult to repeat.

The present invention provides a deposition method avoiding this issue. Thus, this method enables to deposit particles of micrometric size or of several hundreds of nanometers, on substrates having a surface area that may range up to several tens of square centimeters. This method is further simple and fast to implement to perform the organized particle deposition.

### SUMMARY OF THE INVENTION

Thus, the technical solution provided in the context of the present invention comprises homogenizing the particle bath, by means of a magnetic stirrer or with a pump-driven fluid circulation, thus creating a flow in the medium with a slight movement at the surface of the liquid.

The Applicant has thus developed a method enabling to obtain homogeneous depositions of particles of micrometric size or of a few hundreds of nanometers on large surface areas by making the bath homogeneous, wherein the particles are in suspension.

More specifically, the method according to the present invention aims at a method for depositing particles in the form of an organized monolayer on a substrate. It is characterized in that it comprises the steps of:
controlled stirring of a bath comprising at least one solvent and at least said particles;
dipping of the substrate into said stirred bath;
removal of said substrate from said stirred bath.

Advantageously, said bath comprises a mixture of solvents formed of at least 50%, or even 60%, 70%, or more advantageously still 80% by volume of a first solvent. Further, said first solvent preferentially is ethanol. The volume of the first solvent may be up to 90% of the volume of the bath.

The particle deposition comprises covering the surface with a support, in this particular case with a monolayer of said particles in an organized manner. The particles thus cover the substrate in compact and homogeneous fashion.

Term “substrate” more specifically designates glass, silicon, or DLC (Diamond Like Carbon) deposited on a material.

As already mentioned, the method according to the present invention enables to deposit a particle monolayer on large substrates. Generally, the surface of said substrate ranges between 5 cm2 and 1 m2. It typically ranges between 5 and 400 cm2, and more specifically between 25 and 200 cm2.

The deposition method according to the present invention is particularly well adapted for particles having a size greater than 100 nm. Advantageously, the particle size ranges between 500 nm and 2.6 μm. In a specific embodiment, the particle size is greater than 2.6 μm. According to another specific embodiment, it ranges between 500 nm and 1,000 nm.

The particles are currently spherical, their size being then provided by their diameter. Further, and in the context of the method according to the present invention, the particle size is advantageously monodisperse, the average particle size varying by no more than 5%. Generally, the particles are spherical and monodisperse, and thus enable to obtain an organized layer or deposition.

According to a preferred embodiment, the particles deposited by means of the method of the present invention are silica balls or spheres, having a diameter, as indicated previously, greater than 100 nm and more advantageously ranging between 500 nm and 2.6 μm. A ball diameter equal to 2.6 μm is by no means limiting for the present invention. The balls may thus have a diameter greater than 2.6 μm. In a specific embodiment, this diameter ranges between 500 nm and 1,000 nm.

To implement the method according to the present invention, a solution comprising at least one solvent and said particles is first prepared. The solution or the bath thus obtained is then stirred to be homogenized. Indeed, the controlled stirring of the bath enables to avoid the sedimentation of large particles. Typically, the bath is stirred as soon as the particle density is greater than the density of the solvent mixture and as the particles are large enough to be submitted to the effects of gravity, and thus to be likely to settle. Generally, such conditions correspond to a density equal to 0.9 g/cm³ and to particles having a diameter equal to 100 nm.

The substrate is then dipped into the bath. It is then removed with a removal rate which is especially determined according to the particle concentration. The removal rate may vary according to the nature of the substrate and to the particle size.

Advantageously according to the present invention, the stirring is maintained all along the process (bath preparation/dipping/removal) and more particularly during the dipping and removal steps.

The substrate thus obtained is covered with a particle monolayer. Several monolayers of controlled thickness and nature may be deposited on the substrate surface by repeating the method according to the present invention.

The first step of the method thus is a preparation of the bath useful for the deposition.

Term “solvent” is used to designate a liquid enabling to disperse the particles. The solution or the bath comprises the solvent(s), the particles, and possibly at least one tensioactive agent.

As already indicated, the stirring enables to homogenize the bath and thus to obtain more compact, more homogeneous, and reproducible depositions of particles, especially of large size, including on large surface areas.

According to a preferred embodiment, the stirring of said bath is provided by a circulation of fluid, preferentially the solution such as defined hereabove, by means of a pump. The pump discharge rate is adjusted according to the volume of said solution. However, in practice, it advantageously ranges between 100 and 500 l/h. It preferably ranges between 200 and 400 l/h and more advantageously still between 250 and 300 l/h.

During the stirring, instead of remaining at the surface of the solution, the balls are sucked in and rejected by the pump.

In practice, the pump creates a flow in the medium, in this specific case the mixture of at least the solvent and at least the particles, with a slight movement at the liquid surface.

As an alternative, said bath may be stirred by means of a magnetic stirrer. The rotation rate of the corresponding magnetic bar is adjusted according to the volume of said bath. It typically ranges between 100 and 5,000 rpm, more advantageously between 200 and 600 rpm.

As already mentioned, the particles to be deposited by means of the method according to the present invention are dispersed in a solvent mixture advantageously comprising at least 50%, or even 60%, 70% or more advantageously still 80% of ethanol by volume.

According to the nature of the substrate intended to be covered with an organized particle monolayer, the deposition method according to the present invention is carried out by means of a second solvent selected from among water and butanol.

Thus, for a substrate having a small angle of contact with water (from 5 to 30° for glass and silicon), the second solvent preferably is water. The particles are thus dispersed in a water/ethanol mixture. Water enables to regulate the evaporation of the solvent mixture to avoid repeatability problems in case of too fast an evaporation. The volume ratio between the two solvents preferably is 4/1 to attenuate the forming of holes at the top and of stacks at the bottom, with respect to the monolayer in case of too slow an evaporation.

For a given substrate, the angle of contact with water reveals the aptitude of water to spread on the substrate surface by wettability. It is admitted by those skilled in the art that the angle of contact with water is defined by the angle between the substrate surface and the tangent to the water drop at the point of contact with the surface of the substrate where the water drop has been deposited.

As already mentioned, in order to be able to deposit large particles on a glass substrate, the second solvent preferentially is water. Conversely, according to another specific embodiment of the present invention, butanol is advantageously selected as the second solvent for a DLC-type substrate.

Thus, when the substrate has a rather large angle of contact with water, the solvent mixture is preferentially formed of ethanol/butanol with a 4/1 volume ratio. The presence of butanol enables to properly wet the DLC-type substrate, which has an angle of contact with water of approximately 70°. In addition to promoting the particle organization, ethanol provides a rather fast evaporation, and thus avoids the forming of holes at the top and of stacks at the bottom, as compared with the monolayer in case of too slow an evaporation.

Typically, the deposition method according to the present invention is thus carried out by means of a mixture of two solvents, the volume ratio of the first solvent, preferably ethanol, to the second solvent advantageously being equal to 4/1. The use of a mixture of more than two solvents, advantageously with ethanol as a majority solvent (at least 50% by volume) may also be envisaged in the context of the present invention.

Advantageously, the particle concentration in the bath ranges between 50 g/l and 500 g/l, and more advantageously between 80 and 200 g/l.

Especially when the substrate intended to be covered with a particle monolayer has an angle of contact with water smaller than or equal to 45°, the bath may further contain a tensioactive agent, to improve the homogeneity of the deposition. Thus, the addition of a tensioactive agent such as Triton® X-100 may be necessary to properly wet the substrate.

In the second step, the substrate to be coated is dipped into the stirred bath.

Typically the time for which the substrate is dipped into the bath ranges between 0.5 second and 15 minutes.

In the third step, the substrate is removed from the stirred bath.

Typically, the substrate removal rate ranges between 2 cm/min and 50 cm/min, and more advantageously between 5 and 30 cm/min.

During this removal step, the particles stick to the substrate by capillarity. The removal step is especially associated with the particle concentration in the bath, but also with the size of said particles. A high particle concentration results in a slower removal rate.

Thus, the present invention enables to improve the deposition of large particles on large substrates by homogenizing the bath containing the particles in suspension.

The present invention enables to deposit a monolayer of large organized particles on substrates, which may have a surface area on the order of tens of square centimeters. This method further enables to do away with the particle sedimentation phenomenon observed in the dip coating method. The particle arrangement is compact and orderly.

As a summary, the present invention enables to deposit monolayers of large particles on the surface of various large substrates. The stirring of the solution further comprising the solvents with a majority of ethanol and the particles enables to perform a very organized deposition.

### EMBODIMENTS OF THE INVENTION

The foregoing features and advantages of the present invention will be discussed in the following non-limiting description of the following embodiments in connection with the accompanying drawings.

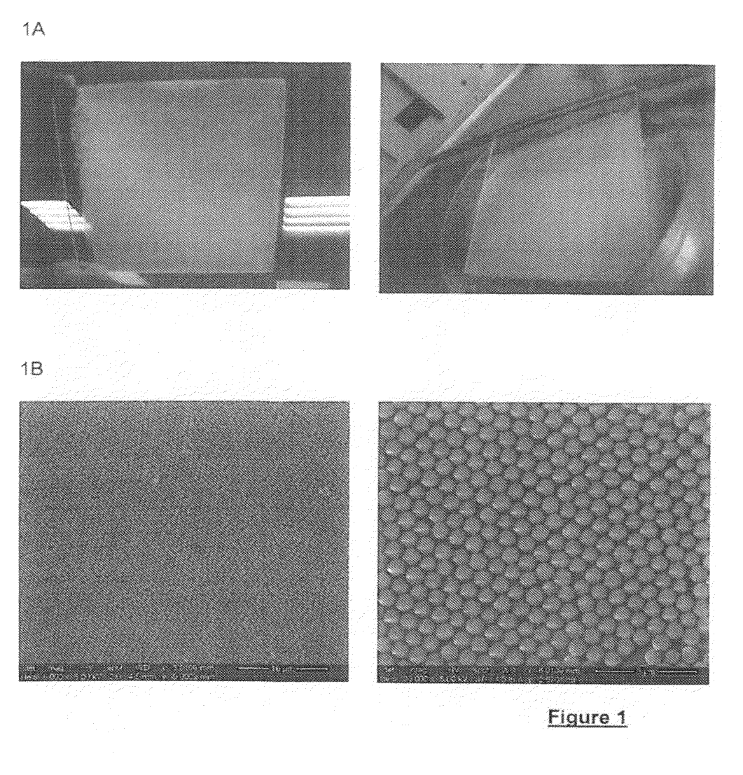

FIG. 1 shows a glass substrate, having a 10×10-cm² surface area covered with a monolayer of SiO₂ balls with a 500-nm diameter by means of the method according to the present invention on a photograph (A) or an SEM image (B) (SEM=Scanning Electronic Microscopy).

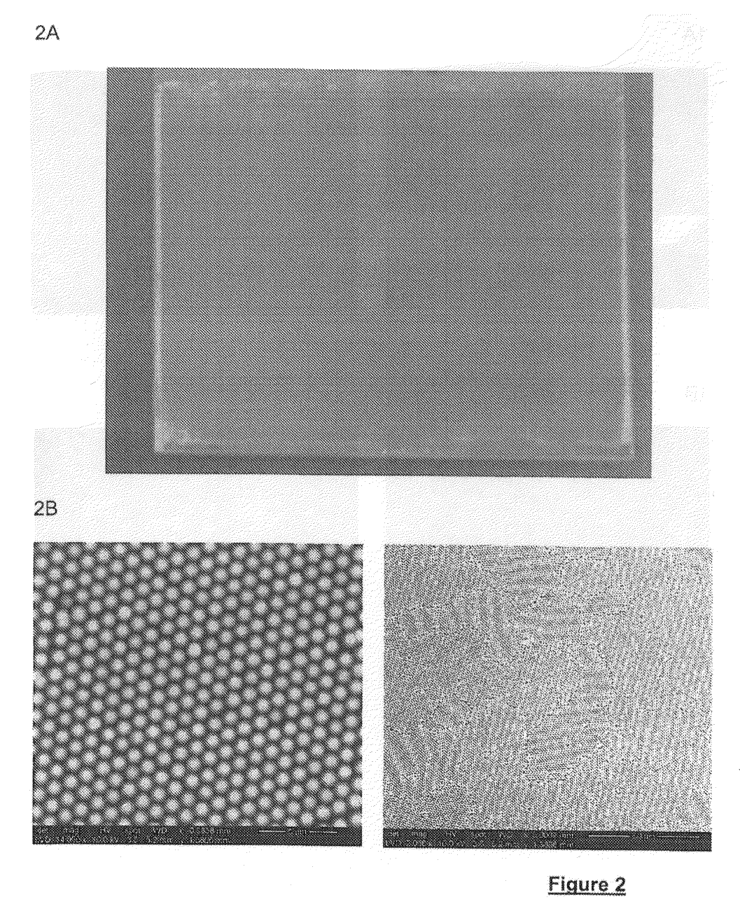

FIG. 2 shows a glass substrate, having a 5×5-cm² surface area covered with a monolayer of SiO₂ balls with a 1-μm diameter by means of the method according to the present invention on a photograph (A) or an SEM image (B).

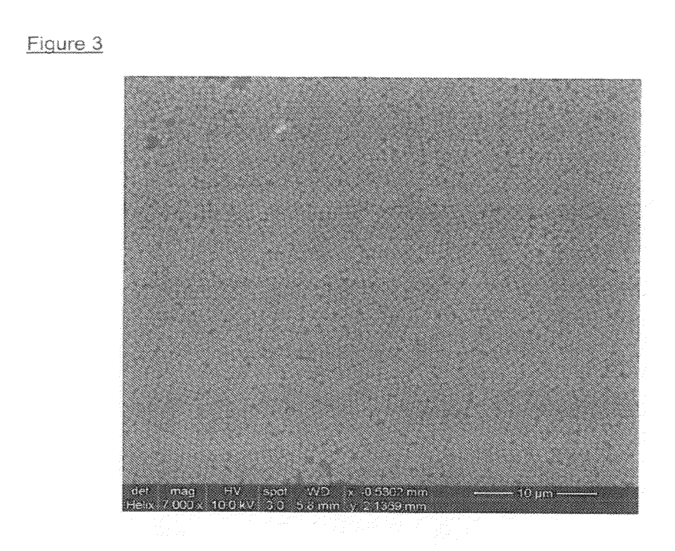

FIG. 3 shows a DLC-type substrate having a surface of a few square centimeters covered with a monolayer of SiO₂ balls with a 500-nm diameter on an SEM image.

FIG. 4 shows a glass substrate covered with a monolayer of silicon balls with a 2.6-μm diameter by means of the method according to the present invention on a photograph (A) or an SEM image (B).

### EXAMPLE 1

This example is illustrated in FIG. 1.

A suspension of silica balls with 108 g/l of particles is prepared by mixing 65 g of SiO₂ balls having a 500-nm diameter and 100 drops of Triton X-100® in 480 ml of ethanol and 120 ml of water. The mixture is stirred with a pump-driven fluid circulation (270 l/h). A glass substrate having a 10×10-cm² surface area is dipped into the mixture.

The substrate is removed from the mixture at a 17-cm/min rate.

### EXAMPLE 2

This example is illustrated in FIG. 2.

A suspension of silica balls with 150 g/l of particles is prepared by mixing 30 g of SiO₂ balls having a 1-μm diameter and 40 drops of Triton X-100® in 160 ml of ethanol and 40 ml of water. The mixture is stirred with a magnetic stirrer (430 rpm). A glass substrate having a 5×5-cm² surface area is dipped into the mixture.

The substrate is removed from the mixture at a 21-cm/min rate.

### EXAMPLE 3

This example is illustrated in FIG. 3.

A suspension of silica balls with 150 g/l of particles is prepared by adding 7.5 g of SiO₂ balls having a 500-nm diameter in a mixture formed of 40 ml of ethanol and 10 ml of butanol. The mixture is stirred with a magnetic stirrer (360 rpm). A DLC-type substrate of a few square centimeters is dipped into the mixture.

The DLC-type substrate is removed from the mixture at a 7-cm/min rate.

### EXAMPLE 4

This example is illustrated in FIG. 4.

A suspension of silica balls with 300 g/l of particles is prepared by adding 72 g of SiO₂ balls having a 2.6-μm diameter in a mixture formed of 200 ml of ethanol and 40 ml of water. The mixture is stirred with a magnetic stirrer (400 rpm). A glass substrate having a 20 cm² surface area is dipped into the mixture.

The glass-type substrate is removed from the mixture at a 28-cm/min rate.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method for depositing particles in the form of an organized monolayer on a substrate, comprising the steps of:
controlled stirring of a bath comprising at least said particles and a mixture of solvents formed of at least 50% by volume of ethanol;
dipping of the substrate into said stirred bath;
removal of said substrate from said stirred bath.

2. The deposition method of claim 1, wherein the particles are of a size greater than 100 nm.

3. The deposition method of claim 1, wherein the stirring of said bath is provided by a pump-driven fluid circulation.

4. The deposition method of claim 1, wherein said bath is stirred by a magnetic stirrer.

5. The deposition method of claim 1, wherein the solvent mixture comprises tow solvents including a second solvent selected from among water and butanol.

6. The deposition method of claim 5, wherein a volume ration of ethanol to the second solvent is equal to 4/1.

7. The deposition method of claim 1, wherein the particles are spherical and monodisperse.

8. The deposition method of claim 1, wherein the particles are silica balls or spheres.

9. The deposition method of claim 1, wherein the substrate comprises glass or DLC (Diamond Like Carbon).

10. The deposition method of claim 1, wherein a surface of the substrate ranges between 5 cm² and 1 m².

11. The deposition method of claim 1, wherein concentration of the particles in the bath ranges between 50 g/l and 500 g/l.

12. The deposition method of claim 1, wherein removal rate of the substrate ranges between 2 cm/min and 50 cm/min.

13. The deposition method of claim 1, wherein the bath further contains a tensioactive agent.

14. The deposition method of claim 1, wherein said size ranges between 500 nm and 2.6 μm.
